(19) United States
(12) Patent Application Publication
(10) Pub. No.: US 2012/0191817 A1
(43) Pub. Date: Jul. 26, 2012

(54) PRODUCT TRACKING BASED ON SCANNED INDICIA

(76) Inventor: Eugene Sayan, Massapequa, NY (US)

(21) Appl. No.: 13/275,851

(22) Filed: Oct. 18, 2011

Related U.S. Application Data
(60) Provisional application No. 61/434,759, filed on Jan. 20, 2011.
(60) Provisional application No. 61/437,452, filed on Jan. 28, 2011.
(60) Provisional application No. 61/548,325, filed on Oct. 18, 2011.

(51) Int. Cl. G06F 15/16; G06Q 30/00

(52) U.S. Cl. 709/219; 235/385

(57) ABSTRACT

According to an exemplary embodiment of the invention, a method for tracking a unit of goods includes sending, by a supplier device, a first message to a server including a code of a product tag and a supplier location of the supplier device, wherein the code uniquely identifies the unit from other units of a same type, recording, by the server, a data record including the code and the supplier location, scanning, by a consumer device, the product tag to retrieve the code, sending, by the consumer device, a second message to the server including the code; and sending, by the server, a third message to the consumer device including the supplier location. The supplier and consumer devices are remote from the server.

### CROSS-REFERENCE TO RELATED APPLICATIONS

This application claims priority to U.S. Provisional Application No. 61/434,759 filed on Jan. 20, 2011, and U.S. Provisional Application No. 61/437,452 filed on Jan. 28, 2011, and U.S. Provisional Application No. 61/548,325 filed on Oct. 18, 2011, the disclosure of each is incorporated by reference herein.

### BACKGROUND

1. Technical Field

The present disclosure relates generally to product tracking based on scanned indicia, and more particularly to product tracking based on scans of indicia by mobile devices.

2. Discussion of Related Art

Mobile Commerce, also known as M-Commerce or mCommerce, is the ability to conduct commerce using a mobile device, such as a mobile phone, a Personal digital assistant (“PDA”), a Smartphone, a Tablet Personal Computer (“PC”), or other emerging mobile equipment such as Dashtop mobile devices. A Smartphone combines the functions of a PDA and a mobile phone, and includes a mobile operating system (“OS”) such as Android™ OS, Iphone™ OS, Blackberry™ OS, etc. A Tablet PC is a tablet-sized computer that has several features of a full-size PC and may also include a mobile OS. Examples of Tablet PCs include the iPAD™, the Samsung Galaxy Tab™, the PlayBook™, etc. Dashtop mobile devices refer to wireless mobile devices mounted on the dashboard of a vehicle.

Recently, brick and mortar business owners and big-box retailers have made an effort to take advantage of mobile commerce by utilizing a number of mobile capabilities such as location based services, barcode scanning, and push notifications to improve the customer experience of shopping in physical stores. By creating what is referred to as a ‘bricks & clicks’ environment, physical retailers (bricks) enable customers to access the common benefits of shopping online (such as product reviews, information, and coupons) while still shopping in the physical store. A matrix code, also termed a two-dimensional (“2D”) barcode is a 2D way to represent information. It is similar to a linear 1D barcode, but can represent more data per unit area. A Quick Response (“QR”) code is an example of the matrix code. QR codes are now seen in advertisements and can be labeled on goods. A barcode scanner can be used to scan the QR code and interpret the embedded information. Due to the incorporation of cameras into mobile devices, a mobile device can function like a barcode scanner to scan the QR code and interpret the embedded information, and the display of the mobile device can be used to display the information to a consumer.

### SUMMARY

According to an exemplary embodiment of the invention, a method for tracking a unit of goods includes sending, by a supplier device, a first message to a server including a code of a product tag and a supplier location of the supplier device, wherein the code uniquely identifies the unit from other units of a same type, recording, by the server, a data record including the code and the supplier location, scanning, by a consumer device, the product tag to retrieve the code, sending, by the consumer device, a second message to the server including the code; and sending, by the server, a third message to the consumer device including the supplier location. The supplier and consumer devices are remote from the server.

According to another exemplary embodiment of the invention, a method for tracking a unit of goods includes scanning, by a mobile device, a product tag of a unit of goods to retrieve a code, wherein the code uniquely identifies the unit from other units of a same type, sending, by the mobile device, a first message to a server including the code, a destination time, and a destination location, recording, by the server, a data record including the code, the destination time, and the destination location, and sending, by the server, a notification message when the destination time is exceeded without receipt of a second message from a second device, wherein the second message includes a location of the second device that corresponds to the destination location and the code. The mobile device and the second device are remote from the server.

According to still another exemplary embodiment of the invention, a system for tracking products includes a server including a database, and managing a supplier portal and a consumer portal, a supplier device external to the server and including a supplier application that is configured to communicate with both the supplier portal and the consumer portal, and a consumer device external to the server and including a consumer application that is configured to communicate with only the consumer portal. The consumer device is configured to scan indicia on a product tag to retrieve a code that uniquely identifies a unit of goods from other units goods of a same type, and send a first message including the code and a location of the consumer device to the server across a cellular network via the supplier portal. The server is configured to create a record in the database including the code and tracking information including the location, and send a second message to the consumer device including the tracking information in response to the first message via the consumer portal.

According to an exemplary embodiment of the invention, a server for tracking products includes a memory, a processor, a network adaptor, a first portal and a second portal. The memory stores an interface application and a database. The database stores a record including a tracking code, where the record is formatted to store at least one location. The processor is configured to execute the interface program. The network adaptor is configured to communicate over an electronic network. The first portal is maintained by the interface application and configured to communicate with a supplier application executing on an external supplier device. The second portal is maintained by the interface application and configured to communicate with a consumer application executing on an external consumer mobile device. The interface application inserts a first location into the record in response to receipt of a message via the first portal including the tracking code and the first location. The interface application inserts a second location into the record in response to receipt of a message via the second portal comprising the tracking code and the second location.

A method for tracking a unit of goods according to another exemplary embodiment of the invention includes affixing at least one product tag to a unit of consumer goods, scanning by a mobile device one of the product tags to retrieve a download link to download an application from a remote server, scanning by the mobile device using the downloaded application one of the product tags to retrieve a tracking code and sending a message including the corresponding tracking code to the server, and sending by the server a message to the mobile device including tracking information of the corresponding tracking code in response to receipt of the message.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a system diagram of devices interfacing with a cloud computing platform.

FIG. 2 illustrates diagram of supplier devices and consumer devices interfacing with a cloud computer according to an exemplary embodiment of the invention.

FIG. 3 illustrates a computer server of the cloud computer according to an exemplary embodiment of the invention.

FIG. 4 illustrates software services provided by the computer server according to an exemplary embodiment of the invention.

FIG. 5A illustrates a method of interfacing with the computer server according to an exemplary embodiment of the invention.

FIG. 5B illustrates a method of tracking a unit of goods according to an exemplary embodiment of the invention.

FIG. 5C illustrates a method of tracking a unit of goods according to another exemplary embodiment of the invention.

FIG. 5D illustrates a method of tracking a unit of goods according to yet another exemplary embodiment of the invention.

FIG. 6 illustrates a process flow diagram of interactions between supplier and consumer devices, and the computer server according to an exemplary embodiment of the invention;

FIG. 7 illustrates an example of a screen that may be presented by an application of the supplier or consumer devices according to an exemplary embodiment of the invention.

FIG. 8 illustrates another example of a screen that may be presented by the application according to an exemplary embodiment of the invention.

### DETAILED DESCRIPTION

It is understood in advance that although this disclosure includes a detailed description on cloud computing, implementations of the teachings recited herein are not limited to a cloud computing environment. Rather, embodiments of the present invention are capable of being implemented in conjunction with any other type of computing environment now known or to be later developed.

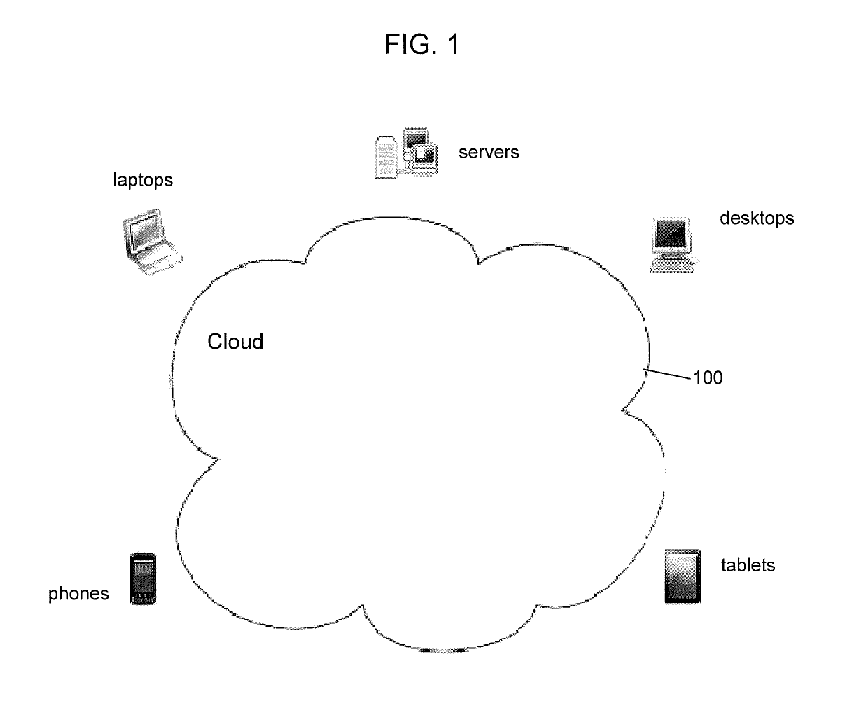

FIG. 1 illustrates a general diagram of a various devices such as laptops, servers, desktop computers, tablet computers, and smart-phones receiving cloud computing services from the cloud 100. Cloud computing is the delivery of computing as a service rather than a product, whereby shared resources, software and information are provided to computers and other devices over a network (e.g., typically the Internet). Cloud computing provides computation, software, data access, and storage services that do not require end-user knowledge of the physical location and configuration of the system that delivers the services.

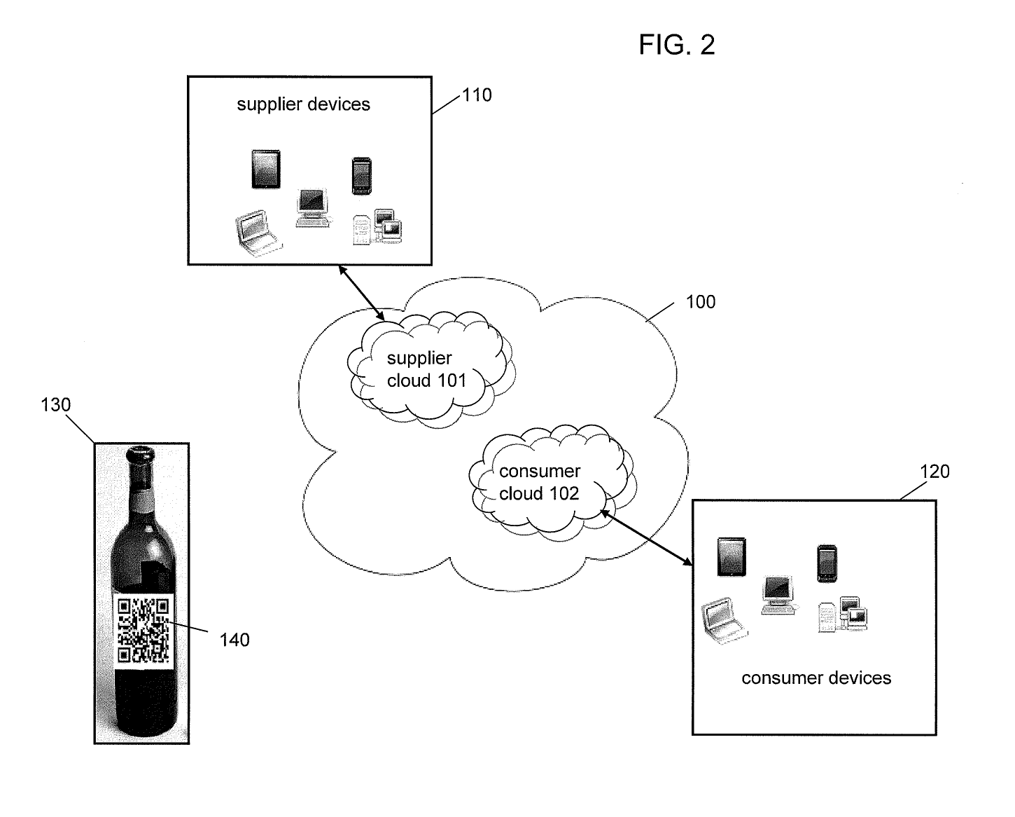

FIG. 2 illustrates a commerce system according to an exemplary embodiment of the invention. The devices of FIG. 1 are divided into supplier devices 110 and consumer devices 120 and the cloud 100 includes a supplier cloud 101 that interfaces with the supplier devices 110 and a consumer cloud 102 that interfaces with the consumer devices. The supplier devices 110 or the consumer devices 110 include software and hardware to scan product tags 140 (e.g., indicia) of one or more products 130. The software and hardware will be discussed in more detail below. In the example shown in FIG. 2, the product tag is a two dimensional barcode (e.g., a Quick Response code) and the product is a bottle of wine. However, this is merely one example of the product tag 140 and embodiments of the invention are not limited thereto. For example, other examples of the product tag 140 will be discussed in more detail below. Further, while the product is illustrated as a bottle of wine, embodiments of the invention are not limited thereto. For example, the product tag 140 can be located on a various products.

In at least one embodiment of the invention, the cloud 100 is a hybrid cloud where the supplier cloud 101 is implemented by a private cloud and the consumer cloud 102 is implemented by a public cloud. In a public cloud, resources are dynamically provisioned to the general public on a fine-grained, self-service basis over a network via web applications/web services, from an off-site third-party provider. In a private cloud, these services are only provided to a single organization or a select group. Commerce related information is exchanged between the cloud 100 and the supplier devices 110 and between the cloud 100 and the consumer devices 120.

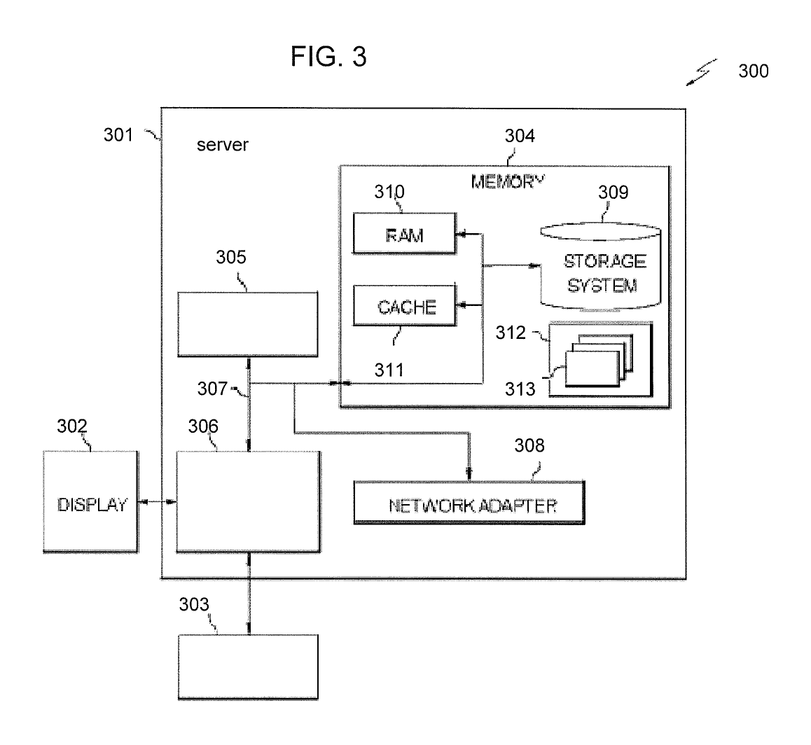

The cloud 100 is supported by a cloud computing infrastructure, which may include a single cloud computing node or a network of interconnected cloud computing nodes. Referring to FIG. 3, a schematic of an example of a cloud computing node is shown. Cloud computing node 300 is only one example of a suitable cloud computing node and is not intended to suggest any limitation as to the scope of use or functionality of embodiments of the invention described herein. Referring to FIG. 3, the cloud computing node 300 includes a computer server 301, which may operate with numerous other general purpose or special purpose computing system environments or configurations. Examples of well-known computing systems, environments, and/or configurations that may be suitable for use with computer server 301 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments.

The components of computer server 301 may include, but are not limited to, one or more processors or processing units 305, a system memory 304, and a bus 307 that couples various system components including system memory 304 to processor 305. The bus 307 represents one or more of any of several types of bus structures, including a memory bus or memory controller, a peripheral bus, an accelerated graphics port, and a processor or local bus using any of a variety of bus architectures. By way of example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer server 301 may include a variety of computer system readable media. Such media may be any available media that is accessible by computer server 301, and it includes both volatile and non-volatile media, removable and non-removable media. The system memory 304 may include computer system readable media in the form of volatile memory, such as random access memory (RAM) 310 and/or cache memory 311. The computer server 301 may further include other removable/non-removable, volatile/non-volatile computer system storage media. By way of example, storage system 309 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 307 by one or more data media interfaces. The system memory 304 may include at least one program product having a set (e.g., at least one) of program modules that are configured to carry out the functions of embodiments of the invention. The memory 304 may also include a relational database for storing structured data.

A computer program 312, having one or more program modules 313, may be stored in memory 304, as well as an operating system, one or more application programs, other program modules, and program data. Each of the operating system, one or more application programs, other program modules, and program data or some combination thereof, may include an implementation of a networking environment. The program modules 313 may carry out the functions and/or methodologies of embodiments of the invention as described herein.

The computer server 301 may also communicate with one or more external devices 303 such as a keyboard, a pointing device, a display 302, etc.; one or more devices that enable a user to interact with server 301; and/or any devices (e.g., network card, modem, etc.) that enable the computer server 301 to communicate with one or more other computing devices. Such communication can occur via Input/Output (I/O) interfaces 306. The computer server 301 may communicate with one or more networks such as a local area network (LAN), a general wide area network (WAN), and/or a public network (e.g., the Internet) via network adapter 308. As depicted, network adapter 308 communicates with the other components of computer server 301 via bus 307. It should be understood that although not shown, other hardware and/or software components could be used in conjunction with computer server 301. Examples, include, but are not limited to: microcode, device drivers, redundant processing units, external disk drive arrays, RAID systems, tape drives, and data archival storage systems, etc.

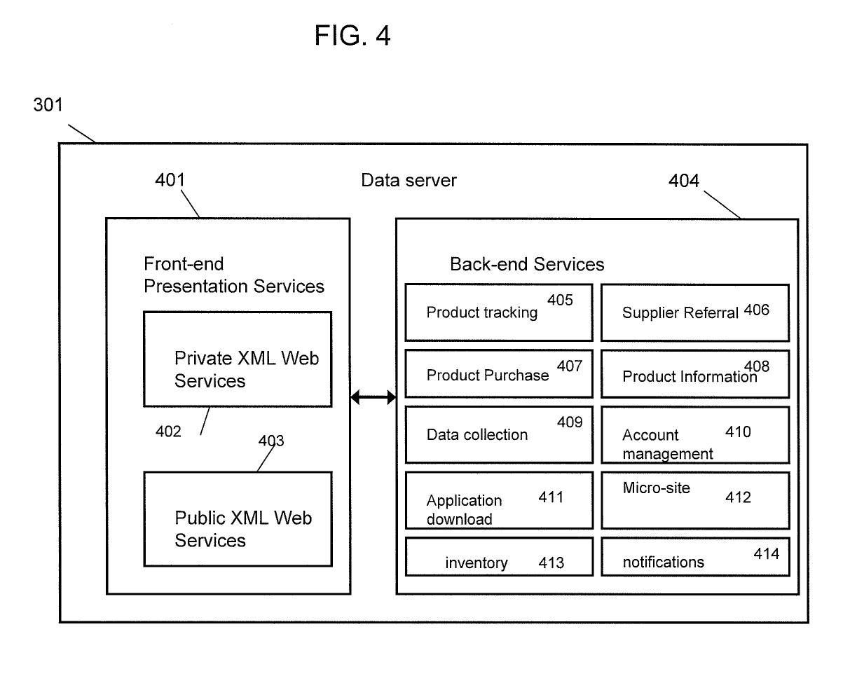

FIG. 4 illustrates software services that may be provided by the computer server 301. The software services may be stored within program 312 or within the program modules 313. The computer server 301 includes a front-end application 401 and a back-end application 404. The front-end application 401 interfaces with an application of the supplier devices 110 and the consumer devices 120, and forwards requests from these devices to the back-end application 404. The computer server 301 can maintain dedicated portals for communicating with the supplier devices 110 and the consumer devices 120. The application on the supplier devices 110 (hereinafter referred to as the “supplier application”) is able to communicate with the computer server 301 through the supplier cloud 101 via a first portal maintained by the computer server 301. The application on the consumer devices 120 (hereinafter referred to as the “consumer application”) is able to communicate with the computer server 301 through the consumer cloud 102 via a second portal maintained by the computer server 301 that is distinct from the first portal.

The front-end application 401 may communicate with the supplier and consumer applications using a Simple Object Access Protocol (“SOAP), which is a protocol specification for exchanging structured information in the implementation of Web Services in computer networks. Soap relies on Extensible Markup Language (XML) for its message format, and may rely on other Application Layer protocols (e.g., Hypertext

Transfer Protocol (HTTP) and Simple Mail Transfer Protocol (SMTP)) for message negotiation and transmission. SOAP can form the foundation layer of a web services protocol stack, providing a basic messaging framework upon which web services can be built. This XML based protocol consists of three parts: an envelope, which defines what is in the message and how to process it, a set of encoding rules for expressing instances of application-defined data types, and a convention for representing procedure calls and responses. For example, the front end application 401 includes XML Web Services, which provide Private XML Web Services 402 and Public XML Web Services 403. The front-end application 401 can use the Private XML Web Services 402 to communicate with the supplier application via the first portal (e.g., the supplier cloud 101) and the Public XML Web Services 403 to communicate with the consumer application via the second portal (e.g., the consumer cloud 102). For example, in an exemplary embodiment of the invention, messages received from the supplier devices 110 are processed by the Private XML Web Services 402 and messages received by the consumer devices 120 are processed by the Public XML Web Services 403. In an alternate embodiment of the invention, messages received by the supplier devices 110 are handled by the Private Web Services 402 or the Public XML Web Services 403 (e.g., via the first or second portals) and messages received by the consumer device 120 are only handled by the Public XML Web Services 403.

The supplier application may store a port address and a password, and use the stored port address and/or password to access the Private XML Web Services 402. The consumer application (or the supplier application) may store a port address, and use the stored port address to access the Public XML Web Services 403 without a password. The port addresses may differ from one another and each distinct port address may correspond to a distinct portal of the server 301.

As discussed above, the front-end application 401 can forward requests from the supplier and the consumer application to the back-end application 404 for various services. The back-end application 404 may provide various services such as a product tracking service 405, a supplier referral service 406 (also known as vendor referral), a product purchase service 407, a product information service 408, a data collection service 409, an account management service 410, an application download/update service 411, a micro-site service 412, an inventory service 413, a notification service 414, etc. The back-end application 404 may provide additional services or fewer than the above-described services. While each service is shown as being in a separate service modules, one or more of these services may be provided in a single module.

The services provided by the back-end application 404 may store data generate as a result of use the corresponding service in a database in the memory 304 or within an external database that is accessible to the computer server 301. Although not shown in FIG. 4, the computer server 301 may include one or more firewalls to prevent unauthorized access to the data stored therein.

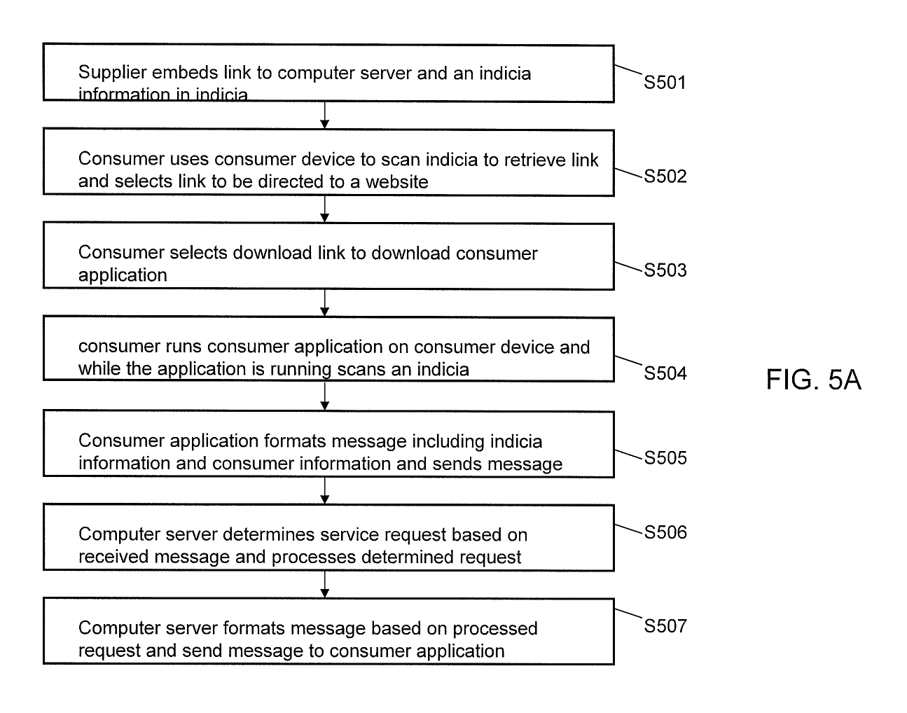

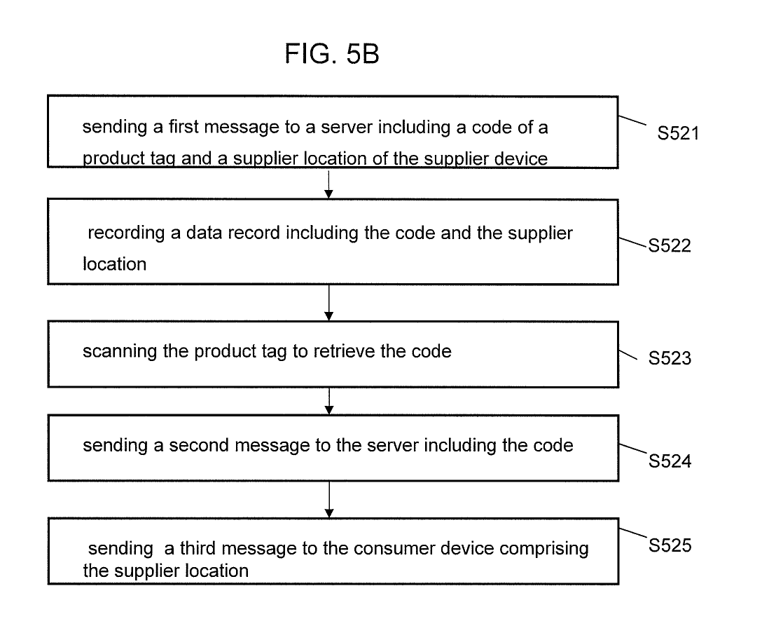

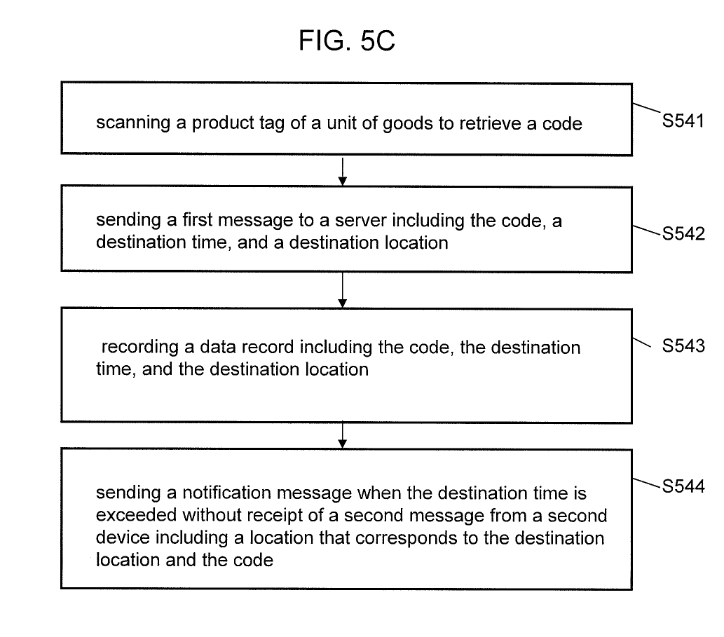

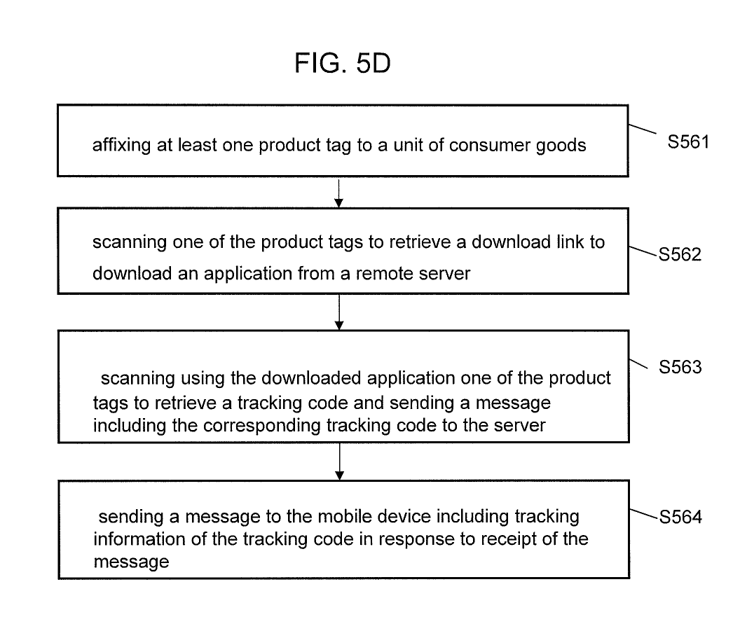

FIG. 5A illustrates a method for providing information to a consumer device 120 using the above-described computer server 301. The consumer device 120 may be one of various devices such as a laptop computer, a desktop computer, a smart-phone, a PDA, a tablet computer, etc. Referring to FIG. 5A, a supplier (e.g., a manufacturer, a wholesaler, a retailer, etc.) embeds a link to the computer server 301 and indicia information (e.g., a product identifier, a tracking code) in an indicia (S501). The indicia may be affixed to or embedded within a product, a physical advertisement (e.g., a newspaper, magazine, a billboard), an electronic advertisement (e.g., displayed in a television commercial). The indicia is any encoding unit such as a barcode or a radio frequency (“RF”) tag. The barcode can be a 1-D barcode or a 2-D barcode such as a Quick Response (“QR”) code.

For example, the link may be a first data field in the QR code and the indicia information may be located in a second data field in the QR code. However, bar-code versions of the indicia are not limited to use of QR codes as various other matrix barcodes may be used.

When the indicia is a barcode, the consumer device 120 includes a scanning devices such as a 1D barcode scanner, a 2D barcode scanner, or a camera to capture an image of the barcode, and the device 120 has the requisite software to interpret and decode data from the captured image.

When the indicia is an RF tag, the consumer device 120 includes a scanning device such as an RFID reader or an NFC reader, which can apply an appropriate RF field to the tag. The RF tag may be an RF identification (“RFID) tag or a near field communication (“NFC”) tag. For example, application of an RF field by an RFID or NFC reader of the consumer device 120 causes the tag to output a signal including the link and the indicia information. When the indicia is an RF tag, the consumer device 120 has the requisite software to control the reader, interpret, and decode data from the output signal.

The consumer device 120 may includes a modem (e.g., a cellular modem) that enables the software of device 120 (e.g., a Web browser) to access the internet. The supplier devices 110 may have a similar configuration to the consumer device 120.

A consumer uses the consumer device 120 to scan the indicia to retrieve the link and then selects the link to be directed to a website or a landing page (S502). For example software of the consumer device 120 can cause a web browser of the device 120 to be directed to the website. In at least one embodiment of the invention, the website is managed by the computer server 301. The website provides a download link that is selected by the user of the consumer device 120 to download the consumer application (S503). When the website is managed by the computer server 301, in at least one embodiment of the invention, the application download services 411 of the back-end application 404 provides the consumer application to the consumer device 120 via web services of the front-end application 401. The server 301 can use the wireless application protocol (“WAP”) to send the consumer application to the consumer device 120. In an alternate embodiment of the invention, selection of the link embedded within the indicia causes the consumer application to send a message to the computer server 301. In response to the message, the application download services 411 of the back-end application 404 sends a WAP push (e.g., a specially encoded message that includes a link to a WAP address) to the consumer device 120. Upon receiving the WAP push, the consumer device 120 gives the user an option to download the consumer application from the computer server 301.

Upon receipt of the consumer application, the user of the consumer device 120 runs the consumer application and scans the indicia (S504). The indicia may be the same indicia that was initially scanned by the consumer device 120 or a different indicia with similar information. The indicia information may be encrypted such that it is only decodable by the consumer application. For example, when a device without the consumer application scans the indicia with the encrypted indicia information, that device can only interpret the link to download the consumer application, but cannot interpret the indicia information. The consumer application decodes or decrypts the indicia information and formats a message including the decoded or decrypted indicia information and consumer information (hereinafter referred to as the “consumer message”) and sends the consumer message to the computer server 301 via the consumer cloud 102 (S505).

As discussed above, the indicia information may include a tracking code and/or a product identifier. The indicia information will be discussed in greater detail below. The consumer information may include consumer identifying information (e.g., a location of the device, a device identifier, consumer name, a user name, etc.), payment information (e.g., credit card numbers, billing name, billing address, etc.), contact information (mailing address, email address, phone number, instant message user id, social network user id, etc.) and demographic information (e.g., gender, age, salary range, interests, etc.). The consumer application may include an interface that allows the user to enter the identifying, demographic, payment, and contact information. The consumer application may be configured to extract this information from other programs on the consumer device. The consumer application may query the user for their permission before accessing this information.

The consumer device 120 has location based services to determine the location. The location based services may include a global positioning system (“GPS”) positioning or global system for mobile communications (“GSM”) that determines or approximates the location (e.g., a geographic latitude and longitude) of the device. For example, when the consumer device 120 includes the GPS, it can determine its location from GPS signals received from satellites. GSM is based on signal strength with respect to nearby antenna masts. For example, the location may be determined via multilateration of radio signals between (several) radio towers of a network (e.g., a cellular network) and the consumer device 120. As discussed above, the consumer device 120 may include a cellular modem to transmit the radio signals. To determine the location using multilateration of radio signals, the device 120 can emit at least a roaming signal to contact a next nearby antenna tower, but it may also use signals it emits during active calls. The supplier device 110 may have the same location based services as the consumer device 120.

The computer server 301 (e.g., the front-end application 401) determines a particular service request based on the message received from the consumer application and forwards the determined request to the appropriate service for processing (S506). For example, if the request is for product tracking, the product tracking service 405 processes the request, if the request is for vendor information, the supplier referral service 406 processes the request, if the requesting is for product purchase, the product purchase service 407 processes the request, and if the request is for product information, the product information service 408 processes the request. The computer server 301 then formats a message based on the processed request (e.g., hereinafter referred to as the “server message”) and sends the server message to the consumer application (S507). The server message will be discussed in more detail below.

The computer server 301 can directly forward the received consumer information and the indicia information to the data collection services 409 or the other back-end services may forward data based on the received consumer information and indicia information to the data collection services 409. The data collection service 409 enables the computer server 301 to collect information on users, which may be used by the other services to improve the experience of a consumer. For example, assume the product purchase service 407 has purchased a number of products for users ranging in age from 18-25. This information can be stored by the data collection services 409. Thus, the next time a purchase is made by the purchase service 407 by a user in that same age range, the data collection service 409 can recommend to the user one of the other products that are typically purchased by users in that age range. For example, the data computer 301 can send a message to the consumer device 120 including information about the recommended product or an ability to automatically purchase the recommended product.

The data collection service 409 can generate statistics on individual users or groups of users in response to the scanned indicia. For example, the statistics could indicate that 20% of males ranging in age 18-25 purchase one soft drink while the remaining 80% purchase a second soft drink. The server 301 can make these statistics available to subscribed users (e.g., manufacturers, vendors, etc.). For example, the accounts management service 410 can maintain accounts for the subscribed users to access these statistics.

In an exemplary embodiment of the invention, the consumer application queries the user to enter contact information (e.g., email address, phone number, instant message user id, social network user id, etc.) of other individuals that may be interested in downloading the consumer application. Once entered, the consumer application can send a message to computer server 301 with the contact information, and the server 301 will send a message including the above described download link to the other individual using the entered contact information.

As discussed above, the supplier device 110 may have hardware that is similar or the same as the consumer device 120. The supplier application may be downloaded to the supplier device 110 in a similar manner to that of the consumer application. For example, the supplier device 110 can scan indicia to retrieve a link that is selected by the user for downloading the supplier application. The computer server 301 can facilitate the download of the supplier application as opposed to the consumer application by identifying the supplier device 110. For example, the computer server 301 can store a list of supplier locations or device identifiers of known supplier devices, and when the download link is selected by a device having one of these know supplier locations or device identifiers, the computer server 301 sends the supplier application to the supplier device 110. When the supplier application is run, similar to consumer application, a subsequent scan by the supplier device 110 of the indicia sends a message to the computer server 301 (e.g., hereinafter referred to as the “supplier message”).

The supplier message may be sent via the supplier cloud 101. The supplier message may include indicia information of the scanned indicia and supplier information (e.g., the location of the supplier device 110, a device identifier of the supplier device 110, etc.). The back-end application 404 of the computer server 301 can processes service requests in response to the supplier message, format messages based on the processed requests, and send these messages to the supplier application.

As discussed above, either the consumer device 120 or the supplier device 110 can scan the indicia and a corresponding application (e.g., consumer application or supplier application, which may be mobile application, hereinafter referred to as the “scanning application”) on the device decodes indicia information from the indicia and formats a message including the indicia information and consumer or supplier information. The indicia information is derived from the indicia. For example, the indicia information may include a unique tracking code and/or a product identifier.

The product identifier may be a Stock Keeping Unit (“SKU”) code, a Universal Product Code (“UPC”) (e.g., 12 digits), a European Article Number (“EAN”), a Global Trade Item Number (“GTIN”), an Australian Product Number (“APN”), etc.

The scanning application sends the formatted message (hereinafter referred to as the “request message”) to the computer server 301 (e.g., over a cellular network via the consumer cloud 102 or supplier cloud 101). In response to the request message, the computer server 301 can reply with a message including supplier/vendor information, general product information, or product tracking information (e.g., hereinafter referred to as the “response message”). The response message can be formatted (filtered) based on whether it was requested by the consumer application or the supplier application, so that the experience is tailored to the needs or permissions of the requesting party. Further, in response to the request message the computer server 301 can initiate a purchase of a product that corresponds to the product identifier. The scanning application may include a field in the request message indicating the type of information or transaction requested. For example, the scanning application can enable a user to set this field.

Alternately, the computer server 301 may infer the type of information or transaction that is being requested based on the information that is sent in the request message. For example, if the request message includes the tracking code, the computer server 301 can infer that a request for product tracking information is being made. In an alternate embodiment, the scanning application is only capable of requesting one type of information and the computer server 301 determines this type based on the identity of the scanning application. When general product information is requested by the scanning application, computer server 301 includes product information of a product corresponding to the received product identifier in the response message and forwards the response message to the scanning application. The product information may be supplied by the product information services 408 of the back-end application 404. The product information may include a product description, product details (e.g., dimensions, weight, model number, average customer review rank, technical details, etc.), customer reviews, etc. The computer server 301 can filter the product information based on the identity, location, and preferences of the requesting device or application. A supplier device 120 may be privy to more detailed product information than a consumer device 110. For example, the computer server 301 can format the product information such that it includes the information that is considered most useful to a salesman who sells the scanned product, in response to a request message from a supplier device 120. The computer server 301 can omit or emphasize details based on the location of the sending device. For example, if the computer server 301 determines that the location of the consumer device 110 is within a warm climate, it may be programmed to omit the cold climate based features from the product information. The product information may also include information of other products that are related to the product identifier. For example, the data collection services 409 can maintain statistics of products that are typically purchased along with a product corresponding to the product identifier. The computer server 301 can include information of these additional products within the product information sent in the response message.

The accounts management service 410 of the back-end application 404 can manage/store accounts for users (e.g., manufacturers, vendors) to remotely enter the product information and their locations. In an alternate embodiment, the computer server 301 can automatically enter/update the product and location information by downloading data from vendor or manufacturer computers or websites. For example, the computer server 301 can automatically update the product information for a product and the location of a vendor by parsing known vendor websites. The vendor locations and product information may also be entered manually by a local user of the computer server 301 using the external device 303.

As discussed above, the request message may include consumer information. The consumer information may include user contact information (name, mailing address, geographic location, email address, phone number, etc.), demographic information (e.g., gender, age or age range, salary or salary range, interests, etc.), past purchase information, etc. The request message may also include a time/date when the indicia was scanned.

The data collection services 409 of the back-end application 404 can determine the level of interest in the corresponding product based on how often the product identifier is received (scanned) and use the received location and demographic information to determine how the level of interest for the corresponding product varies from one region to another or varies from one demographic group to another (e.g., males 18-25, salaries above 50k, etc.). The data collection services 409 can store this interest information and grant subscribers access to such.

The product information and vendor information may be stored within micro-sites that are managed by the micro-site management services 412 of the computer server 301.

Each micro-site can correspond to a manufacturer, a wholesaler, or vendor/supplier. The account management service 410 can maintain accounts that enable a user to remotely log-on to the computer server 301 to make changes to their corresponding micro-site. The micro-site can provide product information on a product associated with the scanned product identifier, information of the manufacturer that makes the product, or information about a vendor that supplies the product.

When the indicia are located on products themselves, a scan of the indicia by the supplier device 110 or the consumer device 120 can provide tracking information. For example, as discussed above, the indicia information may include a tracking code. The tracking code is unique to a particular unit of consumer goods and is linked to tracking information that is stored on the computer server 301. The tracking information can be managed by the product tracking services 405 of the back-end application 404. The tracking information may be updated by the product tracking services 405 based on tracking messages received each time the indicia located on the product is scanned along various stages of a supply chain.

FIG. 5B illustrates a method of performing product tracking according to an exemplary embodiment of the invention. Referring to FIG. 5B, the method includes a supplier device sending a first message to a server including a code of a product tag and a supplier location of the supplier device (S521), the server recording a data record including the code and the supplier location (S522), a consumer device scanning the product tag to retrieve the code (S523), the consumer device sending a second message to the server including the code (S524), and the server sending a third message to the consumer device comprising the supplier location (S525).

FIG. 5C illustrates a method of performing product tracking according to another exemplary embodiment of the invention. Referring to FIG. 5C, the method includes a mobile device scanning a product tag of a unit of goods to retrieve a code (S541), the mobile device sending a first message to a server including the code, a destination time, and a destination location (S542), the server recording a data record including the code, the destination time, and the destination location (S543), and the server sending a notification message when the destination time is exceeded without receipt of a second message from a second device including a location that corresponds to the destination location and the code (S544).

When a product with the product tag is routed (e.g., shipped) from one party to another (e.g., from a manufacturer to a wholesaler), it is expected that the routing will occur within a certain pre-determined period of time (e.g., within a number of days, weeks, etc.). The operational guidelines or security policies of the manufacturer may mandate that the product be shipped within a certain period of time (hereinafter referred to as a “freshness period”. The server 301 may store a freshness period for each product or for each unique code. The above-described destination time/date can be calculated based on the shipping time/date and the freshness period. For example, the destination time/date can be calculated by adding the freshness period to the shipping time/date. When the product tag is scanned (e.g., by a mobile device), the time of scan can be sent along with the indicia information (e.g., code, product identifier), and/or the location of the device to the server 301. The server 301 can then calculate a time difference between the time of scan and the destination time. The time difference calculation may be limited to only being performed when the destination location matches or is similar to (e.g., a pre-defined distance away from) the scanned location. If the time difference is within a pre-defined threshold period (e.g., a number of seconds, minutes, hours, days, etc.), the product has been routed in adherence to the guidelines. A different freshness period and/or threshold period may be stored by the server 301 for each product or code.

However, if the time difference is outside the threshold period, the sever 301 may send out a notification to the routing party or to another party in the supply chain indicating that the guidelines have not been adhered to. Further, if the product has not been scanned by destination time plus the threshold period, the notification described in the method of FIG. 5C can be sent out.

When a product tag is scanned by either the supplier device or the consumer device, the server 301 can respond with freshness information, which is displayed on the scanning device by the corresponding application (e.g., the supplier application or the consumer application). The freshness information can include a timestamp of when that product was shipped, an expiration date, product information, etc. For example, the expiration date may be stored by the server 301 for each product or code, and thus a scan of the product tag by the consumer device or the supplier device can cause its corresponding application to display the expiration date and possibly a warning if the expiration date has been exceeded.

FIG. 5D illustrates a method of performing product tracking according to yet another exemplary embodiment of the invention. Referring to FIG. 5D, the method includes affixing at least one product tag to a unit of consumer goods (S561), a mobile device scanning one of the product tags to retrieve a download link to download an application from a remote server (S562), the mobile device scanning using the downloaded application one of the product tags to retrieve a tracking code and sending a message including the corresponding tracking code to the server (S563), and the server sending a message to the mobile device including tracking information of the tracking code in response to receipt of the message (S564). Each product tag includes un-encrypted first field and an encrypted second field. The first field includes the download link and the second field includes the tracking code that distinguishes the units from one another.

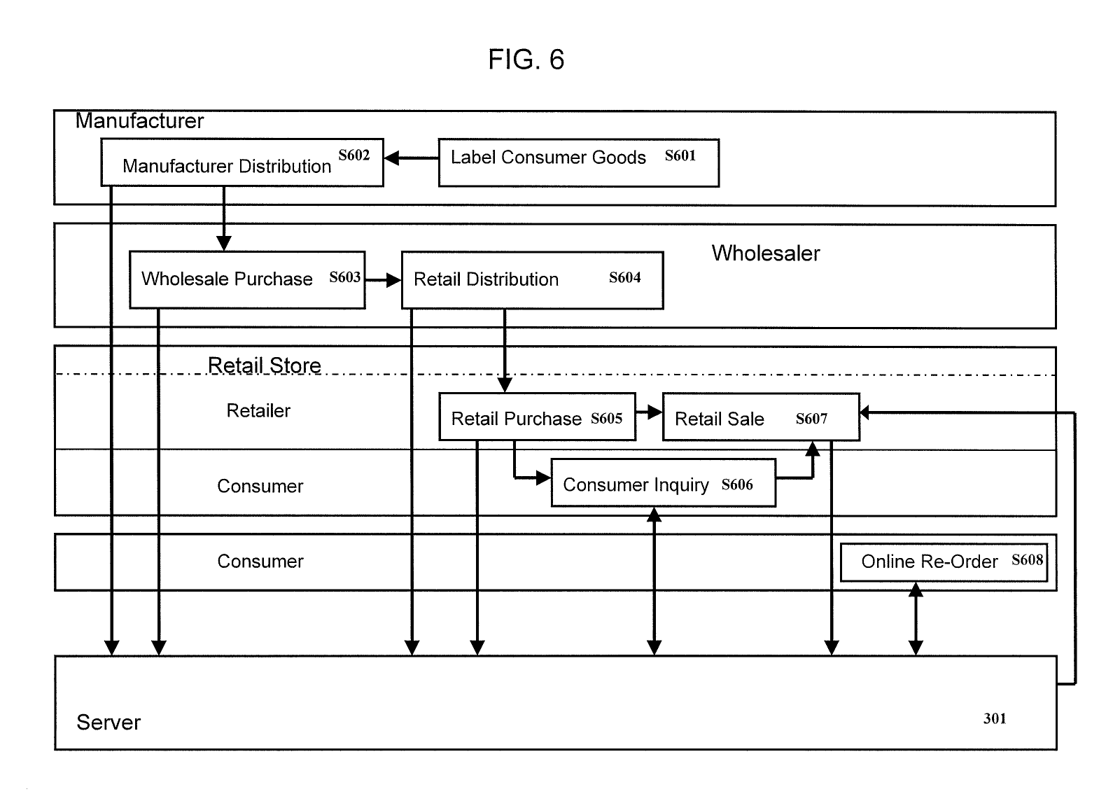

FIG. 6 illustrates an exemplary process flow diagram showing interactions between a manufacturer and the computer server 301, a wholesaler and the computer server 301, a retailer and the computer server 301, and a consumer and the computer server 301 according to an exemplary embodiment of the invention. Prior to distribution of a unit of consumer goods, the manufacturer labels the unit with a product tag (S601).

The product tag includes the above described indicia. As discussed above, the indicia may include a unique tracking code (or a serial number), which enables the product to be tracked. Units of a consumer good of a same product have the same product identifier, but would have different tracking codes. For example, this allows two bottles of the same type of wine from the same manufacturer to be distinguished from one another and tracked.

As an example, the tracking code may include 256 characters of data. However, the tracking code is not limited thereto, as the tracking code may include numerals, a combination of characters and numerals, can be less than or greater than 256 characters, etc. The tracking code may be encrypted within the indicia. The product tracking services 405 of the computer server 301 may be configured to decrypt the tracking code and report tracking information to the supplier device 110 or the consumer device 120 in response to receipt of the tracking code.

The tracking code may include an index number and/or attribute information of the product. The tracking code itself or the index number may be used to reference additional attribute information that is stored on the computer server 301. For example, the tracking code or the index number may be used to access corresponding records maintained by the product tracking services 405 that include tracking information on the scanned product. The attribute information can be any information relating to the unit of consumer goods, which a manufacturer, wholesaler, retailer, or consumer would like to track. For example, the attribute information could include information relating to the raw materials used to make the unit of goods, a data and time the raw materials were received, the quality assurance (“QA”) plan that was used to assure the quality of the unit goods, steps of the QA plan that were followed, a date and time the unit of goods was created, what machines were used to assemble the unit of goods, etc.

The attribute information for the product may be entered manually or automatically into the records. For example, when the attribute information is automatically input, the information can be obtained by the product tracking services 405 automatically from servers within a manufacturing supply chain of the manufacturer, an accounting department, etc. For example, the product tracking services 405 can be configured to interface with external servers, such as raw material servers or accounting systems to update the attribute information of each unit of tracked goods. Then prior to distributing the labeled units, the manufacturer may use the supplier application on the supplier device 110 to scan the product tag of each unit that is scheduled to be shipped to a particular wholesaler, retailer, or consumer (S602). The scanning retrieves the tracking code from the product tag. The supplier application can then forward the tracking code and the location of the supplier device 110 to the server 301. For ease of discussion, the below assumes that the manufacturer ships the units to the wholesaler, wholesaler ships the units to the retailers, and consumer purchase the units from the retailers. However, in alternate embodiments, the manufacturer can ship the units directly to the retailers or directly to the consumers.

In an exemplary embodiment of the invention, a manufacturer system interfaces (e.g., through a wire or wirelessly) with multiple supplier devices 110 or scanning devices (e.g., cameras, barcode scanner) that are mounted within the manufacturing facility to scan and interpret the product tags. For example, the product tags of units can be automatically scanned by the devices as they pass along a conveyer belt prepared for wholesale shipment. Alternately, instead of using the supplier device 110, the product tag information is uploaded to the server 301 through a system portal from the warehouse management systems of the manufacturer.

The supplier application of the supplier device 110 enables the device to determine the tracking code from the product tag. The supplier application may additionally interpret other information that is present within the product tag, such as the product identifier and the attribute information. As discussed above, the supplier application may be downloaded from the server 301 to the supplier device 120 when the supplier device 110 scans an indicia with the above described link. However, in alternate embodiments, the supplier application is installed on the supplier device 120 using a computer readable medium such as a CD-Rom, flash memory, etc.

As discussed above, when an item of goods is scanned by the supplier device 110, the supplier application can send the location of the supplier device 110 and the tracking code to the server 301. For example, the supplier application can send a message to the server 301 including the tracking code and the location (e.g., hereinafter referred to as the “manufacturer message”) each time an item of goods is scanned, or a single message that combines data for several units. For example, the single manufacturer message could include a single location and several different tracking codes. The manufacturer message may additionally include the product identifier.

In one embodiment, the product tracking services 405 can compare the received location against stored locations of manufacturers, wholesalers, and retailers. For example, the memory 304 of the server 301 can store the manufacturer locations. When the received location corresponds with (or is within a pre-defined radius of) one of the pre-defined manufacturer locations, the server 301 can assume that the received manufacturer message came from an authentic party and update the tracking information associated with the tracking code using information in the manufacturer message. For example, the product tracking services 405 can insert the received location into the tracking information for the tracking code. However, if the server 301 determines that the manufacturer message is not authentic; the server 301 can either ignore the manufacturer message or log the message as an error.

The account management service 410 can maintain an account for the manufacturer to remotely access all of the subsequent locations that the product has been.

For example, as will be described below, others in the supply chain with the supplier device 110 or those outside the supply chain with the consumer device 120 that scan a product tag with the same tracking code may result in their respective locations being appended into the corresponding tracking information. When the manufacturer logs onto their account, they can enter the tracking code as a query to retrieve each location in the associated tracking information. Each location in the tracking information may also include a timestamp at which the product tag was scanned by the corresponding party in the supply chain. Further, the supplier device 110 can also be used to retrieve this tracking information. For example, in one embodiment, the supplier device 110 can be placed in one of a tracking update mode or a tracking retrieval mode. For example, in the tracking update mode, subsequent scans by the supplier device 110 of the tracking code place the location of the device into the corresponding tracking information. However, in the tracking retrieval mode, subsequent scans of the tracking code results in display by the supplier device 110 of the tracking information. The manufacturer message may include a field that indicates whether the tracking update mode or the tracking retrieval mode has been selected so that the server 301 knows how to format the response message. The manufacturer message may include a destination identifier that identifies the destination wholesaler, retailer, or consumer that is scheduled to receive the unit of goods and a scheduled delivery time/date at which it is expected that the unit of goods should be received by the destination. The destination identifier can be a code that identifies the destination site or a location of the destination site. The manufacturer message may include a device identifier that identifies the particular supplier device 110. The manufacturer message may include manufacturing identifying information that uniquely identifies the manufacturing facilities (e.g., name of plant, address of plant, a plant code, etc.).

The product tracking services 405 records data of the messages it receives from the manufacturer. For example, the services 405 can store a record for each unit of goods shipped by the manufacturer in a database on the memory 304. Each record may include product identifying information (e.g., the product identifier, the tracking code, etc.) and origin information (e.g., location of the manufacturer, the manufacturer identifier, time/date of manufacture, time/date of shipment, origin of raw materials used in product, etc.). Further, when corresponding data is available in the tracking message received from manufacturer, each record may also include destination information (e.g., the destined wholesaler/retailer/consumer, the scheduled delivery time/date, the scheduled delivery location, etc.).

The computer server 301 can also maintain an inventory for the manufacturer. For example, the inventory services 413 of the back-end application 404 can be used to maintain the inventory. The inventory services 413 can update the inventory based on the received manufacturer messages and knowledge of the current inventory (e.g., from access to an inventory server of the manufacturer). For example, the inventory services 413 can subtract each unit of goods received in the manufacturing messages from the current inventory. The manufacturer can access the inventory using a personal computer that is attached to the internet or directly through the supplier application on a supplier device 110. For example, the inventory services 413 can format inventory messages including inventory data of the manufacturer and send the inventory messages to the supplier application for display on the supplier device 110. The computer server 301 may require that the manufacturer enter a password before access to the inventory is granted. The manufacturer may correspond to a single manufacturing facility of a corporation. Since a company may have multiple manufacturing facilities, the computer server 301 can link records of several manufacturing facilities to a common company identifier, which enables a query to be performed that joins data from multiple manufacturing facilities. Thus, the computer server 301 can monitor the productivity of each company, facility, and each product produced, regardless of the global location of the facility.

A wholesaler can use a supplier device 110 (hereinafter referred to as the “wholesaler device”) to scan a product tag of a received unit of goods to either indicate that the unit has been received (S603) or to indicate that the unit of goods has been sold to a retailer or a consumer (S604). In an alternate embodiment, a wholesale system uses wholesaler devices or scanning devices to automatically scan the units as they are placed on a conveyer belt upon receipt from the manufacturer.

Similar to the application on the supplier device 110 used by the manufacturer, the application on the supplier device 110 used by the wholesaler (hereinafter referred to as the “wholesaler application”) can send a message for each scanned unit to the product tracking services 405 including tracking information (e.g., the tracking code of the scanned unit, the location of the wholesaler device, the time of scan, origin information, etc.) or an aggregated message that includes data for several scanned units (hereinafter referred to as the “wholesaler message”). The wholesaler application may include an option that allows a user to select between acknowledging receipt of the unit and a sale of the unit. Accordingly, the wholesale message may include a field that indicates whether the scan is to acknowledge receipt or a sale of the unit, so that the server 301 can distinguish the wholesale messages from one another.

The account management service 410 can maintain an account for the wholesaler to remotely access the tracking information that is similar to the one described above for the manufacturer. The wholesaler may also access the tracking information by scanning the product tag. As discussed above with respect to the manufacturer, the wholesaler device can be placed into one of a tracking update mode or a tracking retrieval mode such that subsequent scans of the tracking code either insert information (e.g., location) of the wholesaler into the tracking information or retrieve the tracking information.

The product tracking services 405 can use the data received in the wholesale message to update the record it maintains for each tracking code. For example, the product tracking services can update the record to indicate receipt of the unit by a particular wholesaler and the time/date when the unit received. The computer server 301 can authenticate a particular wholesaler based on the location received. For example, the computer server 301 may store (e.g., in a database in memory 304 or an external storage server) a list of wholesaler locations, and when a message is received with a location that corresponds to (or is within a pre-defined radius of) one of the listed wholesaler locations, the corresponding wholesaler is authenticated. If the wholesaler can not be authenticated, the server 301 can ignore the message or log it as an error.

The wholesale message may additionally include at least one of a product identifier of the unit (e.g., UPC), a device identifier of the wholesaler device, a wholesale identifier identifying the wholesaler (e.g., name, address, a wholesaler code, etc.), a scheduled destination identifier (e.g., a code, address, location, of the site the unit is to be delivered), a scheduled delivery time/date, etc. The product tracking service 405 can update/append the record it maintains for the tracking code with the additional information that is present in the received message.

The server 301 can generate an inventory for the wholesaler based on the received wholesaler messages. For example, each time a unit of goods is scanned by the wholesale device, the server 301 can add that unit to the inventory of the corresponding wholesaler. The wholesaler can access its inventory in a manner similar to that described above for the manufacturer.

The wholesaler application can be used to process an invoice received along with a shipment of goods. For example, the wholesaler application can automatically generate an electronic bill of lading based on the scanned units. A bill of lading is a document that can be issued by the buyer to indicate, which of the goods listed in the invoice have been received. The invoice may include a barcode that lists all of the shipped products. The wholesaler device can scan the invoice barcode to initialize a bill of lading with the quantities and identities of products that were ordered, and then the quantities received can be automatically updated as each unit of goods is scanned by the device. The wholesaler application can enable a user to send the resulting bill of lading back to the originating manufacturer. The creation and update of the bill of lading may also be performed by the server 301. For example, information from the scanned invoice may be sent to the server 301 by the wholesaler application, which is used by the server 301 to create the bill of lading. Further, the server 301 can update the bill of lading based on each subsequent scan by the wholesaler. The server 301 can then send the bill of lading to the manufacturer or the manufacturer can access such by remotely logging on to an account managed by the server 301.

In response to receipt of a purchase order from a retailer or a consumer, the wholesaler can use the wholesaler device to scan a unit of goods to send a wholesale message to the server 301 that acknowledges the sale to the retailer/consumer or a planned shipment of the unit to the retailer/consumer (S604). The user of the wholesaler application may need to set the wholesaler device to acknowledge sale (or shipment) of the goods before scanning the units. The wholesale message can include a field that indicates that the unit is sold or to be shipped. The wholesale message sent to the server 301 to indicate sale or shipment of the unit may include similar information to that of the message that was sent to indicate reception of the unit. For example, the message may include the tracking code of the unit and the location of the wholesale device. The wholesale message may also include at least one of a product identifier, shipping time/date, a destination that the unit will be shipped to (e.g., a location, address, or code of vendor or consumer), a scheduled delivery time/date, a device identifier of the wholesale device, a wholesale identifier (e.g., a code, name, or address associated with the wholesaler), etc. The wholesale messages indicating sale or shipment can be used by the server 301 to update the inventory of the wholesaler. For example, each time a unit of goods is scanned by the wholesale device for shipment to a retailer or consumer, the server 301 can delete that item from the inventory of the wholesaler.

A vendor that receives a shipment of goods from the wholesaler can use a supplier device 110 (hereinafter referred to as the “retail device”) to scan the product tag of each unit received to indicate either that the unit has been received (S605) or that the unit has been sold or shipped (S607). The vendor may be a retail store or an online store. The application of the retail device (hereinafter referred to as the “retail application”) can send a message to the server 301 that includes the tracking code of the scanned unit, the location of the retail device, the time of scan, etc. (hereinafter referred to as the “retail message”). The retail message may include the tracking codes of a single scanned unit or several. The retail application may enable a user to select between acknowledging receipt of the goods from a party (e.g., from the manufacturer or the wholesaler) and acknowledging sale or shipment of the goods to a party (e.g., to a consumer). Accordingly, the retail message may include a field that indicates whether the scan is to acknowledge receipt of the goods or a sale/shipment of the goods.

The product tracking services 405 can use the data received in the retail messages to update or append to other data in the tracking information in the record it maintains for each tracking code. For example, the product tracking services 405 can update the tracking information of the record to indicate the address of the retailer and the time/date when the unit was received. For example, the product tracking services could maintain a record that includes the tracking code along with sequential entries of each location that scanned a product tag including the tracking code and the time of the scan. The server 301 can authenticate the retailer based on the location received in the retail message before entering its information into the record. For example, the retailer can be authenticated when a received location corresponds to (or is within a pre-defined radius of) locations of known retailers or authorized retailers stored on the server 301. The retail message may include a device identifier of the retail device, retailer identifying information (e.g., a code of the retailer, a name of the retailer, an address of the retailer, etc.), destination information (e.g., location or address of consumer, scheduled delivery time/date, etc.

The account management service 410 can maintain an account for the vendor to remotely access the tracking information that is similar to the one described above for the manufacturer. The vendor may also access the tracking information by scanning the product tag. As discussed above with respect to the manufacturer, the retail device can be placed into one of a tracking update mode or a tracking retrieval mode such that subsequent scans of the tracking code either insert information (e.g., location) of the vendor/retailer into the tracking information or retrieve the tracking information.

The computer server 301 can generate an inventory for the retailer based on the received retail messages. For example, each time a unit of goods is scanned by the retail device, the inventory services 413 of the server 301 can add that unit to the inventory of the retailer. The retailer can access its retail inventory in a manner similar to that described above for the manufacturer.

A consumer can use a consumer device 120 device including the above-described consumer application to scan the product tag of a unit of goods located at the retailer (e.g., in a physical retail store) (S606). In response to the scan of the product tag, the consumer application can send a message to the server 301 (e.g., via the consumer cloud 102) including the tracking code and the location of the consumer device 120, or a message including several previously scanned tracking codes and the location (hereinafter referred to as the “consumer tracking message”). Similar to the consumer message, the consumer tracking message may include the product identifier, time/date of scan, and consumer information such as contact information (email address, phone number, etc.), demographic information (e.g., gender, age, salary range, interests, etc.), etc. As discussed above the data collection services 409 can store information associated with the product that indicates the consumer's interest in the product. Further, the data collection services 409 can store user information of the consumers that scanned the tracked unit or a non-tracked product. The information in the consumer tracking message can be linked to the tracked unit or the non-tracked product. For example, the information can be stored in the record having the tracking code or stored in a record associated with the product. As additional consumers scan the unit, their corresponding consumer information can be appended. The server 301 can enable authorized users (e.g., a manufacturer, the wholesaler, retailer, etc.) to access some or part of this consumer information. For example, the server 301 can send a message to the authorized users including the consumer information of those that have scanned their products.

As discussed above, when a consumer uses the consumer device 120 to scan a product tag, the consumer application can display product and vendor data from a micro-site that is managed by the computer server 301. The micro-site can provide a shopping experience that is tailored by a manufacturer or a vendor. For example, manufacturers and vendors can log-on to the server 301 and customize their micro-site using tools provided by the micro-site services 412. The server 301 can associate each micro-site with a product identifier of a scanned product tag. For example, multiple micro-sites can provide information on the same product identifier since many vendors can provide the same product. The micro-site may include an overview of the product, its features, specifications, real customer reviews and ratings, service details, videos, etc. The micro-site may also provide a product history report showing a history of the locations the unit has been and the dates/times the product has been at those locations. For example, this history may be provided from the records maintained by the product tracking services 405. Accordingly, the product history report may list the manufacturing facility that assembled/produced the unit, the raw materials that were used to manufacture the unit, the quality assurance (“QA”) process that was use to validate the quality of the unit, the steps of the QA that were followed, when the product was shipped to a particular wholesaler or retailer, from which warehouse location the unit was shipped from, when the unit arrived at the retail store, etc. Due to the wealth of information provided, the consumer can quickly make an informed decision on the spot, without the need to leave the retail location to do more research on the product or shop at competitors.

The information presented to the consumer can be tailored according to the location of the consumer. For example, if the consumer had scanned the unit in a retail store at a particular mall, along with information on the product, they can be presented with coupons or advertisements for that particular retail store, or other stores in the mall.

When the consumer purchases the unit from within a retail store, the vendor can use his retail device to scan the unit to indicate that the unit has been purchased (S607). Before the unit is scanned, the vendor may need to set the retail device to indicate that subsequent scans are to acknowledge sales. The retail application can send a retail message to the server 301 that indicates the unit has been purchased by a consumer. The retail message may include a field that indicates the unit has been purchased as opposed to being received. The retail message may include the tracking code, the product identifier, the location of the retail device, time/date of scan, etc. The retail message may include a device identifier of the retail device. The retail message may include a retailer identifier identifying the retailer (e.g., a code of the retailer, a name of the retailer, an address of the retailer, etc.).

The product tracking services 405 can use the data received in the retail messages to update the record it maintains for each tracking code. For example, the product tracking services 405 can update the tracking information in a record having the tracking code to indicate the unit was purchased from a particular retailer and the time/date when the unit was purchased. The server 301 can authenticate the retailer based on the location received in the message. For example, the server 301 can store a list of locations of known retailers, and authenticate a particular retailer when the received location corresponds to (or is within a pre-defined radius of) one of the listed retailer locations. When present, the retailer may be authenticated by the retail identifier in the retail message. The server 301 may ignore retail messages where the retailer cannot be authenticated or log them as errors.

The inventory services 413 can update the inventory of the retailer based on the received retail messages that indicate a sale of the unit. For example, for each retail message received that indicates a sale, the inventory services can delete the corresponding unit from the inventory of the retailer. The retailer may access this inventory in a manner similar to that described above for the manufacturer.

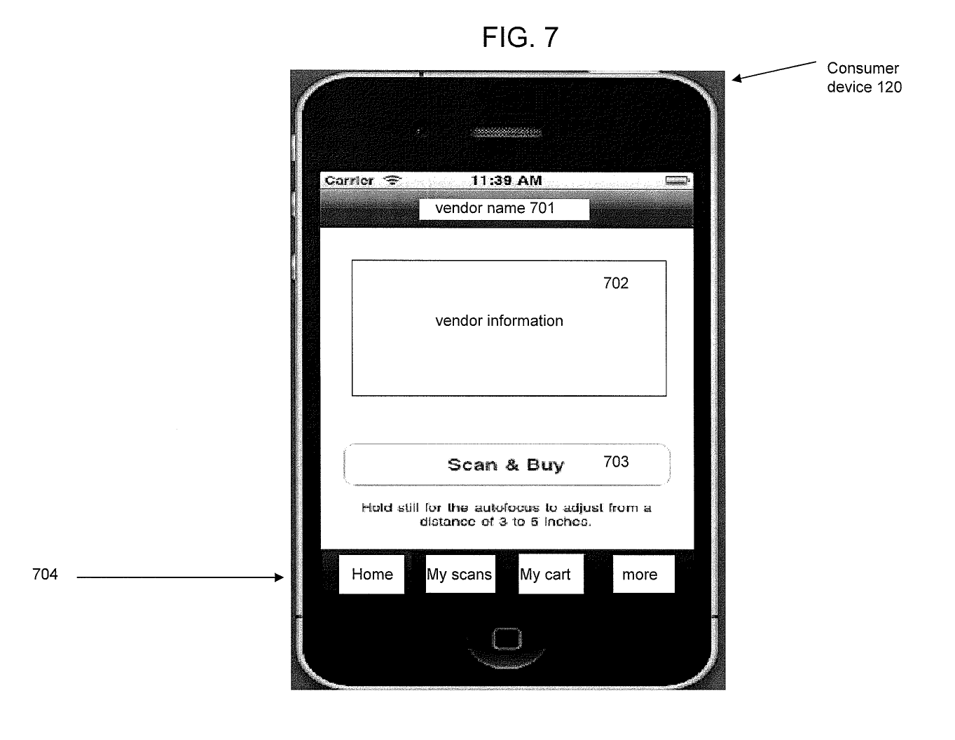

A consumer can also use the consumer device 120 to scan a product tag to purchase a product like the scanned unit or to re-order a product like the scanned (S608). For example, when the product tag is scanned outside of a retail store, the consumer application presents data from one of the above-described micro-sites to the user to enable purchase of the scanned unit or re-order of a product like the scanned unit. In alternate embodiment, the consumer application uses the personal information of the consumer (e.g., name, address, credit card information) to automatically purchase or re-order (“Buy Now”) the unit or a product like the unit from the original vendor, another vendor/retailer, or directly from the wholesaler or manufacturer. For example, FIG. 7 is an example of a screen that may be presented by the consumer application using data provided by the computer server 301 from the micro-sites it manages. The screen in this example displays the name 701 of a preferred vendor, vendor information 702, a Scan and Buy option 703, and various function selections 704.

When the Scan and Buy option 703 is selected, each product tag subsequently scanned that refers to a product carried by the vendor is automatically purchased using the product purchase service 407 of the back-end application 404. The product purchase service 407 can validate the transaction and interface with a server of the vendor to complete the purchase. The product purchase service 407 may send a purchase authentication message to the consumer device 120. For example, the consumer application may request the consumer enter a password to authorize the purchase in response to the purchase authentication message. The consumer application can then forward the password (encrypted) to the product purchase service 407, which can compare the entered password against a password that is stored for the consumer. The account management service 410 can maintain accounts for the consumers that store their passwords, credit card information, and address billing information to enable the product purchase 407 service to authenticate the password and complete purchases of the scanned items.

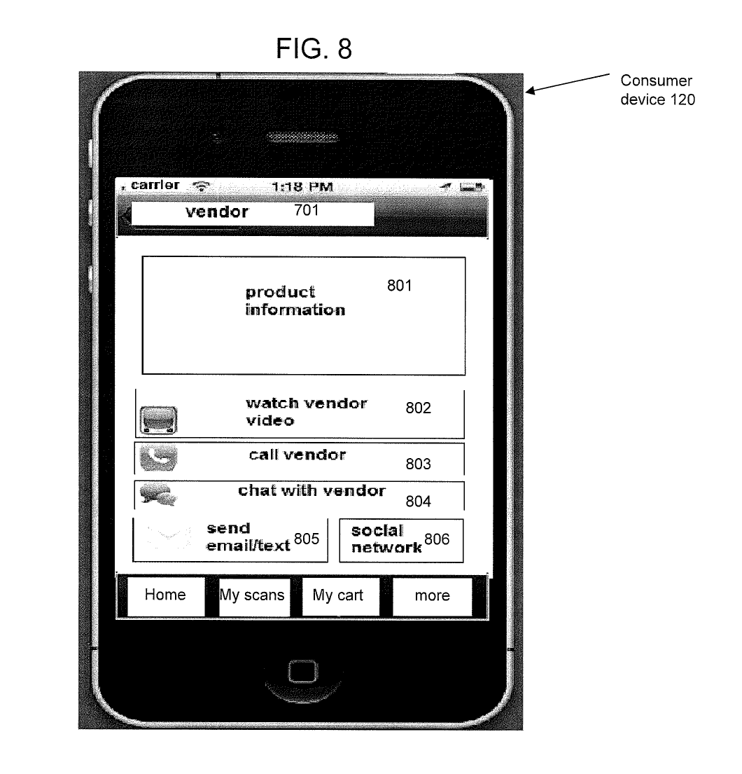

The function selections 704 may include various options such as options to enable the consumer to exit the consumer application, view their past scans, share their past scans with others, view a virtual shopping cart, etc. FIG. 8 illustrates an example of a screen that may be presented by the consumer application of the consumer device 120 after the product tag has been scanned. Referring to FIG. 8, the screen includes product information 801, a video link 802 that when selected displays a video, a call link 803 that when selected automatically calls a vendor (e.g., the nearest with respect to the location of the scanner) that sells the scanned product, a chat link 604 that when selected automatically creates a chat session with the vendor, a email link 805 that automatically sends an email to the vendor, and social network links 806 that when selected allow the user to input their feedback about the product (e.g., indicate to social network they recommend or like the product), follow reports on the product on the social networks, or send a message to a friend. If the product is to be a gift, the consumer application enables the user send a thank you video to the recipient. For example, the consumer application enables the user to enter user information of the recipient, which is sent to the computer server 301. The computer server 301 can store the user information of the recipient and then forward a message to the recipient that enables the recipient to play the video or download the consumer application. The consumer application can also be used to add the scanned item or a product like the scanned item to a virtual shopping cart, which enables the prior scanned items to be purchased at a later time. When the consumer device 120 scans a product tag outside of a retail store, the consumer application can also display the above described product information. This product information can be personalized based on the current location of the user. For example, the product information may include a list of vendors within a pre-defined distance of the scanned location that carry the product. Further, as described above, this product information may include the tracking information associated with the unit of goods. The consumer application can aggregate data/content from different sources and mediums so that only the right amount of information about the product or the manufacturer is presented. The product information presented by the consumer application may include selectable links to other products that were purchased along with the scanned unit of goods (“other products purchased with this”), other products that were purchased by individuals with similar interests (“people like me”). In this way, the presented product information can influence sales within very specific geographic and demographic groups, as well as small micro-segments.

Using the above described system, the computer server 301 can track individual products as they are routed from the manufacturer to wholesaler, from wholesaler to vendor, and from vendor to consumer. The computer server 301 can make tracking information associated with the tracking of these products available to various entities, such as corporations, manufacturers, wholesalers, retailers, vendors, and consumers.

In an exemplary embodiment of the invention, the notification service 414 of the back-end application 404 can notify a corporation, a manufacturer, a wholesaler, a vendor, a retailer, or a consumer if an item fails to arrive at one of the scheduled destination sites. For example, if the vendor has placed an order for a unit of goods, and the unit has not been scanned by the wholesaler by the scheduled delivery time/date (or within a pre-defined tolerance of the scheduled delivery time/date), the notification service 414 can flag this event and send out a notification to the appropriate party. The notification service 414 can periodically evaluate the records maintained by the product tracking service 405 to determine whether any expected delivery times/dates have been missed. The party receiving the notification can then take appropriate steps such as initiating an internal investigation. The notification can be sent in various manners, such as an email, a text message (SMS), a social network message, etc. In an alternate embodiment, the notification is sent to and displayed by the consumer application or the supplier application. The notification may include contact information of the party that is assigned to resolve such issues. The notification may include a selectable link, that when selected, sets up an electronic chat, telephones, or enables the user to enter a personal message to be relayed to the assigned party via text message, email, or social network. The records stored by the server 301 may include a flag that indicates whether the unit has missed a delivery time/date that can be set when the delivery time/date is missed and cleared when the delivery is finally made. When the flag is cleared, the notification service 414 may be configured to update the remaining scheduled delivery time/dates based on the time difference between the missed delivery time/date and the actual delivery time/date to prevent additional notifications. Alternately, when the flag is cleared, the updated scheduled delivery time/dates may be sent in notifications to parties that are further along in the supply chain or to the consumer.

In a further embodiment, a salesman may use a supplier device 120 that includes a supplier application that enables him to scan the product tags to view information that will aid him in selling the scanned product tag. For example, a list of commonly asked consumer questions and answers about the scanned unit may be presented to the salesman upon scanning the product tag so that he can educate himself prior to speaking with prospective customers. This ensures that sales associates have instant answers and can provide a higher level of customer service. Instead of wearing a blank expression when asked about specific product details, associates can instead access information from the product tags to efficiently serve the customer with confidence to close the sale.

As discussed above, those in the supply chain (e.g., the manufacturer, the wholesaler, vendor/retailer) can use the supplier devices 120 to access the server 301 through the supplier cloud 101 and the consumer can use the consumer device 110 to access the server 301 through the consumer cloud 102. The server 301 can provide separate portals for entry of the supplier devices 120 via the supplier cloud 101 and entry of the consumer devices 110 via the consumer cloud 102. This enables the server 301 to present different types of data to the requesting devices and prevents certain devices from accessing or updating privileged data. For example, the tracking information on a unit of goods may have details that are only viewable by the supplier and not by the consumers.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

It is to be understood that exemplary embodiments disclosed above are illustrative only, as the invention may be modified and practiced in different but equivalent manners apparent to those skilled in the art having the benefit of the teachings herein. It is therefore evident that exemplary embodiments disclosed herein may be altered or modified and all such variations are considered within the scope and spirit of the invention.

What is claimed:

1. A method for tracking a unit of goods, the method comprising:
sending, by a supplier device, a first message to a server comprising a code of a product tag and a supplier location of the supplier device, wherein the code uniquely identifies the unit from other units of a same type;
recording, by the server, a data record comprising the code and the supplier location;
scanning, by a consumer device, the product tag to retrieve the code;
sending, by the consumer device, a second message to the server comprising the code; and
sending, by the server, a third message to the consumer device comprising the supplier location,
wherein the supplier and consumer devices are remote from the server.

2. The method of claim 1, wherein the server is a cloud computing server.

3. The method of claim 1, wherein the server maintains distinct first and second portals such that messages exchanged between the supplier device and the server are sent through the first portal and messages exchanged between the consumer device and the server are sent through the second portal.

4. The method of claim 1, wherein the sending by the supplier device comprises:
scanning, by the supplier device, the product tag; and
calculating, by the supplier device, the supplier location at or about a time the supplier device scans the product tag using electromagnetic signals received by the supplier device.

5. The method of claim 1, wherein the sending by the consumer device comprises:
calculating, by the consumer device, a consumer location at or about a time the consumer device scans the product tag using electromagnetic signals received by the consumer device; and
inserting, by the consumer device, the consumer location into the second message.

6. The method of claim 5, further comprising appending, by the server, the consumer location into the record.

7. The method of claim 1, wherein the first message comprises a field indicating status of the unit as (i) shipped, (ii) received, or (iii) sold, and the method further comprises updating, by the server, a local inventory or a bill of lading based on the code and the field.

8. The method of claim 1, wherein the first message comprises a device identifier that uniquely identifies the supplier device and the recording is contingent upon the server recognizing the device identifier.

9. The method of claim 1, wherein prior to the scanning by the consumer device, the method further comprises downloading, by the consumer device, a mobile application that performs the scanning and the sending by the consumer device.

10. The method of claim 1, wherein the second message comprises user information of a user of the consumer device and the method further comprises the server appending the user information into the record.

11. The method of claim 1 wherein at least one of the devices is a Smartphone, a tablet personal computer PC, or a personal digital assistant PDA.

12. The method of claim 1, wherein at least one of the devices include a radio frequency identification RFID reader, a near field communication NFC reader, or a camera to scan the product tag.

13. The method of claim 1, wherein at least one of the messages is transferred using a wireless network.

14. The method of claim 1, wherein the product tag is a two dimensional (2D) barcode, a radio frequency identification RFID tag, or a near field communication NFC tag.

15. A method for tracking a unit of goods comprising:
scanning, by a mobile device, a product tag of a unit of goods to retrieve a code, wherein the code uniquely identifies the unit from other units of a same type;
sending, by the mobile device, a first message to a server comprising the code, a destination time, and a destination location;
recording, by the server, a data record comprising the code, the destination time, and the destination location; and
sending, by the server, a notification message when the destination time is exceeded without receipt of a second message from a second device , wherein the second message comprises a location that corresponds to the destination location and the code, wherein the devices are remote from the server.

16. The method of claim 15, wherein the notification message is sent to the mobile device.

17. The method of claim 15, wherein the product tag is a two dimensional (2D) barcode, a radio frequency identification RFID tag, or a near field communication NFC tag.

18. A server for tracking products comprising:
a memory storing an interface application and a database storing a record comprising a tracking code and formatted to store at least one location;
a processor configured to execute the interface program;
a network adaptor configured to communicate over an electronic network;
a first portal maintained by the interface application and configured to communicate with a supplier application executing on an external supplier device; and
a second portal maintained by the interface application and configured to communicate with a consumer application executing on an external consumer mobile device,
wherein the interface application inserts a first location into the record in response to receipt of a message via the first portal comprising the tracking code and the first location, and
wherein the interface application inserts a second location into the record in response to receipt of a message via the second portal comprising the tracking code and the second location.

19. The server of claim 18, wherein the server stores a current time along with each location inserted.

20. The server of claim 18, further comprising sending, by the server, the locations of the record to the supplier application or the consumer application.

21. The server of claim 20, wherein only part of the locations are sent to the consumer application.

22. The server of claim 18, wherein the server maintains an account for a remote user to access information in the record.

23. The server of claim 18, wherein the memory includes a copy of the consumer application for download to the consumer mobile device.

24. A method for tracking a unit of goods comprising:
affixing at least one product tag to a unit of consumer goods, each product tag comprising an un-encrypted first field and an encrypted second field, the first field comprising a download link and the second field comprising a tracking code that distinguishes the units from one another;
scanning by a mobile device one of the product tags to retrieve the download link to download an application from a remote server;
scanning by the mobile device using the downloaded application one of the product tags to retrieve the corresponding tracking code and sending a message including the corresponding tracking code to the server; and
sending by the server a message to the mobile device including tracking information of the corresponding tracking code in response to receipt of the message.

25. The method of claim 24, wherein the scanning by the mobile device using the application and the sending of the message comprises:
calculating, by the mobile device, a location of the device at or about a time of the scanning using electromagnetic signals received by the device; and
inserting the location into the message.

26. The method of claim 24, further comprising the server inserting the location into the tracking information.

27. The method of claim 24, wherein the product tag is a two dimensional (2D) barcode, a radio frequency identification RFID tag, or a near field communication NFC tag.
